(19) United States
(12) Patent Application Publication
(10) Pub. No.: US 2016/0368822 A1
(43) Pub. Date: Dec. 22, 2016

(54) MULTI-COMPONENT COMPOSITION

(71) Applicant: SIKA TECHNOLOGY AG, Baar (CH)

(72) Inventor: Fabio WÜRMLI, Wädenswil (CH)

(21) Appl. No.: 14/902,265

(22) PCT Filed: Jul. 3, 2014
(86) PCT No.: PCT/EP2014/064244

§ 371 Date: Dec. 30, 2015

(30) Foreign Application Priority Data
Jul. 5, 2013 (EP) 13175256.0

(51) Int. Cl. C04B 24/28; C04B 24/12; C04B 22/00; E04F 15/12; C04B 14/06; C08G 59/22; C08G 59/50; C04B 28/04; C04B 24/02

(52) U.S. Cl. CPC C04B 24/281; C04B 28/04; C04B 24/121; C04B 22/0093; C04B 24/02; C04B 14/06; C08G 59/226; C08G 59/5026; E04F 15/12; C04B 2111/62

(57) ABSTRACT

A multi-component composition is described that includes an epoxy component having at least one reactive epoxy resin, one hardener component that includes at least one hardener for the epoxy resin, one cement component including cement and at least one filler, and also from 0.1% to 1% by weight, based on the total weight of the multi-component composition, of at least one polymeric binder that is solid at 23° C. Addition of the at least one polymeric binder can significantly improve relevant properties of the multi-component composition, examples being more particularly adhesion thereof, compressive strength thereof and shrinkage thereof. Also described, is a process for producing a coated substrate with the aid of the composition described above, and also coated substrates that can be produced by a corresponding process.

### TECHNICAL FIELD

The present invention relates to a multicomponent composition comprising an epoxy component, a hardener component, a cement component and 0.1% to 10% by weight, based on the total weight of the multicomponent composition, of at least one polymeric binder which is solid at 23° C.

Further aspects of the present invention relate to the use of the at least one solid polymeric binder for improving the adhesion and/or compressive strength and/or for reducing the shrinkage of a multicomponent composition, to a process for producing floor coverings and to the floor coverings producible by this process.

### STATE OF THE ART

Multicomponent compositions based on epoxy resins on the one hand and cement on the other hand have already been known for many years. These systems have experienced significant advances with the development of water-thinnable amine hardener components for epoxy resins.

Multicomponent compositions can be classified into various types. For example, a PIC (polymer-impregnated concrete) system is based on a resin-impregnated concrete in which the capillary pores of an already hardened cement concrete are filled with a monomer which is then polymerized therein. In the case of PC (polymer-concrete) systems consisting of a multicomponent resin system and cement, the multicomponent resin assumes the function of a binder for cement and water and forms a polymer concrete as a result of addition of inorganic additives. PCC systems are synthetic resin-modified concrete. In contrast to the PIC system, for example, a polymer dispersion is added here to the fresh concrete. Both the cement and the polymer, which is frequently a thermoplastic, act as binders.

The ECC (epoxy-cement-concrete) system is a special type of PCC and can be produced by addition of water-emulsifiable epoxy resins to cement paste and inorganic additives. In this system, the hardening reactions of the cement and the epoxy component proceed in parallel, forming a thermoset network from the epoxy resin. Compositions of this kind have various advantages, for example better processibility of the fresh mortar, better adhesion of the fresh and solid mortar on the substrate, better water retention capacity, increased freeze-thaw resistance and, depending on the epoxy component used, better elasticity of the solid mortar. ECC systems have been known for many years, and so reference may be made here inter alia to EP 0 786 439 A1 as prior art.

DE 101 50 600 A1 describes ECC systems in which an epoxy resin of the bisphenol A or F type and a cementitious binder are used as constituents of a powder component, which is cured by addition of a liquid component containing an amine hardener and water. A further constituent used in the liquid component is relatively large amounts (about 20% of liquid component) of aqueous vinyl- and acrylate-based polymer dispersions. The compositions described in DE 101 50 600 A1 feature good material properties, especially good adhesion, water resistance, elasticity and mechanical stability.

DE 198 12 247 A1 describes similar ECC systems, but these contain, in comparison to the compositions described in DE 101 50 600 A1, as an additional constituent, 1 to 10 parts by weight of paraffin oil. The paraffin oil causes the compositions to have a high freeze-thaw resistance and a reduced tendency to shrinkage.

Finally, EP 2 537 896 A1 describes redispersible epoxy powders which are obtained by reacting epoxy resins in water with a polyvinyl alcohol as dispersant. These redispersible epoxy powders can be used as concrete additives in order to improve the hydraulic stability of the concrete and further properties such as compressive strength, abrasion resistance and resistance to chemicals and solvents. Similar redispersible epoxy powders are also described in EP 2 537 896 A1.

In the recent past, the systems described have been modified by addition of aqueous epoxy resin emulsions. These epoxy resin emulsions, which are hardened with amines dissolved in water, can improve the adhesion of the compositions on moist substrates. In addition, the epoxy resin can assume the function of a temporary moisture barrier. In the course of further processing, these products can be overcoated with pure epoxy products after hardening for only 24 h at 23° C. However, a disadvantage in the case of addition of such liquid polymers is that various properties of the system are adversely affected, especially the strength and adhesion of the system on different substrates. There is therefore a need for multicomponent compositions based on ECC systems where the adverse effects associated with the addition of liquid polymers are essentially compensated for. At the same time, the positive properties brought about by the liquid polymers should be maintained as far as possible. More particularly, there is a need for ECC systems having improved shrinkage characteristics, improved compressive strength and/or improved adhesion compared to the ECC systems having an addition of liquid polymers.

The present invention solves these problems.

### SUMMARY OF THE INVENTION

A first aspect of the present invention accordingly relates to a multicomponent composition comprising
an epoxy component comprising at least one reactive epoxy resin,
a hardener component comprising at least one hardener for the epoxy resin,
a cement component comprising cement and at least one filler, and
0.1% to 10% by weight, based on the total weight of the multicomponent composition, of at least one polymeric binder which is solid at 23° C.

The hardening of the cement component requires water. This water can be added to the multicomponent composition as a separate component, but it is preferable when the water is already part of at least one of the components present, with the exception of the cement component. For example, the water may be present in the epoxy component and/or the hardener component. When the water is part of the epoxy component and/or the hardener component, it is preferable in the context of the present invention when the amount of water in the epoxy component and/or the hardener component is adjusted such that the amount of water when all components are mixed is sufficient for the hardening of the cement.

Epoxy Component

The epoxy component is not subject to any significant restrictions with regard to the reactive epoxy resin to be incorporated. However, it is preferable in the context of the present invention when the epoxy resin is a polyepoxide liquid resin, referred to hereinafter as “liquid resin”. Such liquid resins have a glass transition temperature typically below 25° C., by contrast with what are called solid resins which have a glass transition temperature above 25° C. and can be comminuted to give powders that can be poured at 25° C. In addition, it is preferable in the context of the present invention when the epoxy resin is emulsifiable in water.

In one embodiment, the liquid resin is an aromatic polyepoxide. Suitable examples for this purpose are, for example, liquid resins of the formula (I)

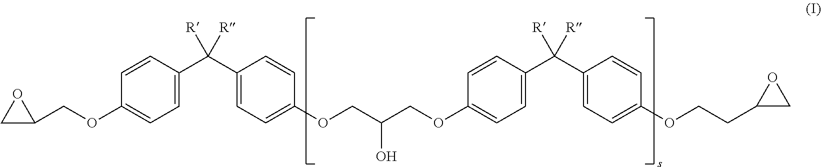

where R′ and R″ are each independently a hydrogen atom or a methyl group, and s on average is a value of 0 to 1. Preference is given to those liquid resins of the formula (I) in which the index s on average is a value of less than 0.2.

The liquid resin of the formula (I) comprises diglycidyl ethers of bisphenol F, bisphenol A and/or bisphenol A/F, where A stands for acetone and F for formaldehyde, which serve as reactants for preparation of these bisphenols. A bisphenol A liquid resin correspondingly has methyl groups, a bisphenol F liquid resin has hydrogen atoms and a bisphenol A/F liquid resin has both methyl groups and hydrogen atoms as R′ and R″ in formula (I). In the case of bisphenol F, it is also possible for positional isomers to be present, especially derived from 2,4′- and 2,2′-bis(hydroxyphenyl)methane.

Further suitable aromatic liquid resins are the glycidylization products of
dihydroxybenzene derivatives such as resorcinol, hydroquinone and catechol;
further bisphenols or polyphenols such as bis(4-hydroxy-3-methylphenyl)-methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)-propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis( 4-hydroxyphenyI)-3,3,5-trimethylcyclohexane (bisphenol TMC), 1,1-bis(4-hydroxyphenyI)-1-phenylethane, 1,4-bis[2-( 4-hydroxyphenyI)-2-propyl]benzene) (bisphenol P), 1,3-bis[2-( 4-hydroxyphenyI)-2-propyl]benzene) (bisphenol M), 4,4′-dihydroxydiphenyl (DOD), 4,4′-dihydroxybenzophenone, bis( 2-hydroxynaphth-1-yl)methane, bis( 4-hydroxynaphth-1-yl)methane, 1,5-dihydroxynaphthalene, tris( 4-hydroxyphenyl)methane, 1,1,2,2-tetrakis(4-hydroxyphenyl)ethane, bis(4-hydroxyphenyl) ether, bis(4-hydroxyphenyl) sulfone,
condensation products of phenols with formaldehyde which are obtained under acidic conditions, such as phenyl novolaks or cresol novolaks, also called bisphenol F novolaks;
aromatic amines such as aniline, toluidine, 4-aminophenol, 4,4′-methylenediphenyldiamine (MDA), 4,4′-methylenediphenyldi-(N-methyl)-amine, 4,4′[-1,4-phenylenebis(1-methylethylidene)]bisaniline (bisaniline P), 4,4′[-1,3-phenylenebis(1-methylethylidene)]bisaniline (bisaniline M).

Also suitable as an epoxy resin is an aliphatic or cycloaliphatic polyepoxide, for example
a glycidyl ether of a saturated or unsaturated, branched or unbranched, cyclic or open-chain C2 to C30 diol, for example ethylene glycol, propylene glycol, butylene glycol, hexanediol, octanediol, a polypropylene glycol, dimethylolcyclohexane, neopentyl glycol or dibromoneopentyl glycol;
a glycidyl ether of a tri- or tetrafunctional, saturated or unsaturated, branched or unbranched, cyclic or open-chain polyol such as castor oil, trimethylolpropane, trimethylolethane, pentaerythritol, sorbitol or glycerol, and alkoxylated glycerol or alkoxylated trimethylolpropane;
a hydrogenated bisphenol A, F or A/F liquid resin, or the glycidylization products of bisphenol A, F or A/F;
an N-glycidyl derivative of amides or heterocyclic nitrogen bases, such as triglycidyl cyanurate and triglycidyl isocyanurate, and reaction products of epichlorohydrin and hydantoin.

Other possible epoxy resins are a bisphenol A, bisphenol F or A/F solid resin which is of similar structure to the liquid resins of the formula (I) already described but instead of the index s has a value of 2 to 12, and has a glass transition temperature above 25° C.

Suitable epoxy resins, finally, are also epoxy resins from the oxidation of olefins, for example from the oxidation of vinylcyclohexene, dicyclopentadiene, cyclohexadiene, cyclododecadiene, cyclododecatriene, isoprene, hexa-1,5-diene, butadiene, polybutadiene or divinylbenzene.

Preferred epoxy resins are liquid resins based on a bisphenol, especially based on bisphenol A, bisphenol F or bisphenol A/F, more preferably bisphenol F and/or bisphenol A epichlorohydrin resin, as commercially available, for example, from Dow, Huntsman and Hexion. These liquid resins have a low viscosity for epoxy resins and, in the cured state, have good properties as coatings. They can optionally be used in combination with bisphenol A solid resin or bisphenol F novolak epoxy resin.

The epoxy resin may comprise a reactive diluent, especially a reactive diluent having at least one epoxy group. Suitable reactive diluents are, for example, the glycidyl ethers of mono- or polyhydric phenols and aliphatic or cycloaliphatic alcohols such as, in particular, the already mentioned polyglycidyl ethers of di- or polyols, and additionally, in particular, phenyl glycidyl ether, cresyl glycidyl ether, p-n-butylphenyl glycidyl ether, p-tert-butylphenyl glycidyl ether, nonylphenyl glycidyl ether, allyl glycidyl ether, butyl glycidyl ether, hexyl glycidyl ether, 2-ethylhexyl glycidyl ether, and glycidyl ethers of natural alcohols, for example C8- to C10-alkyl glycidyl ether or C12- to C14-alkyl glycidyl ether. The addition of a reactive diluent to the epoxy resin brings about better distribution of the epoxy resin and results in more homogeneous through-hardening of the mixture, which prevents quality-impairing defects in the hardened product.

For regulation of the wetting and better distribution in the multicomponent composition in the course of mixing thereof, the epoxy component may appropriately contain up to about 15% by weight, based on the weight of the reactive epoxy resin, of a reactive diluent as described above. Particularly preferred reactive diluents are a cresyl, 2-ethylhexyl or C12-C14 glycidyl ether.

An epoxy component which is particularly preferred in the context of the present invention contains 35% to 50% by weight of a bisphenol F epichlorohydrin resin, 5% to 25% by weight of a bisphenol A epichlorohydrin resin and 2.5% to 5% by weight of a C12-C14 glycidyl ether. The proportion up to 100% by weight in this composition preferably consists of water.

For the epoxy component, finally, it is preferable when it does not contain any redispersible polymer powder or form such a powder; more preferably, the epoxy component does not contain the same material as the polymeric binder which is solid at 23° C. or consist thereof.

Hardener Component

The hardener component of the present invention is likewise not subject to any significant restrictions. In the context of the present invention, however, it is preferable when the hardener for the epoxy resin is in the form of a polyamine. Suitable polyamines are aliphatic, cycloaliphatic, heterocyclic and aromatic polyamines. Preferably, the polyamine used as hardener is a water-soluble or water-dispersible polyamine.

Particularly suitable polyamines are especially the following polyamines:
aliphatic, cycloaliphatic or arylaliphatic diamines, such as, in particular, ethylenediamine, propane-1,2-diamine, propane-1,3-diamine, 2-methyl-propane-1,2-diamine, 2,2-dimethylpropane-1,3-diamine, butane-1,3-diamine, butane-1,4-diamine, pentane-1,3-diamine (DAMP), pentane-1,5-diamine, 1,5-diamino-2-methylpentane (MPMD), 2-butyl-2-ethylpentane-1,5-diamine (C11 neodiamine), hexane-1,6-diamine, 2,5-dimethylhexane-1,6-diamine, 2,2,4- and 2,4,4-trimethylhexamethylenediamine (TMD), heptane-1,7-diamine, octane-1,8-diamine, nonane-1,9-diamine, decane-1,10-diamine, undecane-1,11-diamine, dodecane-1,12-diamine, 1,2-, 1,3- and 1,4-diaminocyclohexane, bis(4-amino-cyclohexyl)methane (H12-MDA), bis(4-amino-3-methylcyclohexyl)methane, bis(4-amino-3-ethylcyclohexyl)methane, bis(4-amino-3,5-dimethylcyclohexyl)-methane, bis(4-amino-3-ethyl-5-methylcyclohexyl)methane (M-MECA), 1-amino-3-aminomethyl-3,5,5-trimethylcyclohexane (=isophoronediamine or IPDA), 2- and 4-methyl-1,3-diaminocyclohexane and mixtures thereof, 1,3- and 1,4-bis(aminomethyl)cyclohexane, 2,5(2,6)-bis(aminomethyl)bicyclo[2.2.1]-heptane (NBDA), 3(4),8(9)-bis(aminomethyl)tricyclo[5.2.1.0^{2, 6}]decane, 1,4-diamino-2,2,6-trimethylcyclohexane (TMCDA), menthane-1,8-diamine, 3,9-bis(3-aminopropyI)-2,4,8,10-tetraoxaspiro[5.5]undecane, and 1,3- and 1,4-bis(aminomethyl)benzene;
aliphatic, cycloaliphatic or arylaliphatic primary triamines, especially 4-aminomethyl-1,8-octanediamine, 1,3,5-tris(aminomethyl)benzene, 1,3,5-tris(amino-methyl)cyclohexane, tris(2-aminoethyl)amine, tris(2-aminopropyl)amine, tris(3-aminopropyl)amine;
aliphatic diamines containing ether groups, especially bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine and higher oligomers of these diamines, bis(3-aminopropyl)polytetrahydrofurans and other polytetrahydrofurandiamines, and polyoxyalkylenediamines. The latter are typically products from the amination of polyoxyalkylenediols and are obtainable, for example, under the Jeffamine® name (from Huntsman), under the Polyetheramine name (from BASF) or under the PC Amine® name (from Nitroil). Especially suitable polyoxyalkylenediamines are Jeffamine® D 230, Jeffamine® D 400, Jeffamine® D 2000, Jeffamine® D 4000, Jeffamine® XTJ-511, Jeffamine® ED-600, Jeffamine® ED-900, Jeffamine® ED-2003, Jeffamine® XTJ-568, Jeffamine® XTJ-569, Jeffamine® XTJ-523, Jeffamine® XTJ-536, Jeffamine® XTJ-542, Jeffamine® XTJ-559, Jeffamine® EDR-104, Jeffamine® EDR-148, Jeffamine® EDR-176; Polyetheramine D 230, Polyetheramine D 400 and Polyetheramine D 2000, PC Amine® DA 250, PC Amine® DA 400, PC Amine® DA 650 and PC Amine® DA 2000;
primary polyoxyalkylenetriamines, which are typically products from the amination of polyoxyalkylenetriols and are obtainable, for example, under the Jeffamine® trade name (from Huntsman), under the Polyetheramine name (from BASF) or under the PC Amine® name (from Nitroil), for example Jeffamine® T 403, Jeffamine® T 3000, Jeffamine® T 5000; Polyetheramine T403, Polyetheramine T5000 and PC Amine® TA 403;
polyamines having tertiary amino groups and having two primary aliphatic amino groups, such as, in particular, N,N′-bis(aminopropyl)piperazine, N,N-bis(3-aminopropyl)methylamine, N,N-bis(3-aminopropyl)ethylamine, N,N-bis(3-aminopropyl)propylamine, N,N-bis(3-aminopropyl)cyclohexylamine, N,N-bis(3-aminopropyl)-2-ethylhexylamine, and also the products from the double cyanoethylation and subsequent reduction of fatty amines derived from natural fatty acids, such as N,N-bis(3-aminopropyl)dodecylamine and N,N-bis(3-aminopropyl)tallowalkylamine, obtainable as Triameen® Y12D and Triameen® YT (from Akzo Nobel);
polyamines having tertiary amino groups and having three primary aliphatic amino groups, such as, in particular, tris(2-aminoethyl)amine, tris(2-amino-propyl)amine and tris(3-aminopropyl)amine;
polyamines having secondary amino groups and having two primary aliphatic amino groups, such as, in particular, 3-(2-aminoethyl)amino-propylamine, bishexamethylenetriamine (BHMT), diethylenetriamine (DETA), triethylenetetramine (TETA), tetraethylenepentamine (TEPA), pentaethylenehexamine (PEHA) and higher homologs of linear polyethylenamines such as polyethylenepolyamine having 5 to 7 ethylenamine units (known as “higher ethylenepolyamine”, HEPA), products from the multiple cyanoethylation or cyanobutylation and subsequent hydrogenation of primary di- and polyamines having at least two primary amino groups, such as dipropylenetriamine (DPTA), N-(2-aminoethyl)-1,3-propanediamine (N3 amine), N,N′-bis(3-aminopropyl)ethylenediamine (N4 amine), N,N′-bis(3-aminopropyI)-1,4-diaminobutane, N5-(3-aminopropyI)-2-methylpentane-1,5-diamine, N3-(3-aminopentyl) pentane-1,3-diamine, N5-(3-amino-1-ethylpropyI)-2-methylpentane-1,5-diamine and N,N′-bis(3-amino-1-ethylpropyl)-2-methylpentane-1,5-diamine,
polyamines having one primary and one secondary amino group, such as, in particular, N-methyl-1,2-ethanediamine, N-ethyl-1,2-ethanediamine, N-butyl-1,2-ethanediamine, N-hexyl-1,2-ethanediamine, N-(2-ethylhexyl)-1,2-ethanediamine, N-cyclohexyl-1,2-ethanediamine, 4-aminomethylpiperidine, N-(2-aminoethyl)piperazine, N-methyl-1,3-propanediamine, N-butyl-1,3-propanediamine, N-(2-ethylhexyl)-1,3-propanediamine, N-cyclohexyl-1,3-propanediamine, 3-methylamino-1-pentylamine, 3-ethylamino-1-pentylamine, 3-cyclohexylamino-1-pentylamine, fatty diamines such as N-cocoalkyl-1,3-propanediamine and products from the Michael-like addition reaction of primary aliphatic diamines with acrylonitrile, maleic esters or fumaric esters, citraconic esters, acrylic and methacrylic esters, acryl- and methacrylamides and itaconic esters, converted in a molar ratio of 1:1, and additionally products from the partial reductive alkylation of primary aliphatic polyamines with benzaldehyde or alter aldehydes or ketones, and partially styrenized polyamines such as Gaskamine® 240 (from Mitsubishi Gas Chemical (MGC));
aromatic polyamines, such as, in particular, m- and p-phenylenediamine, 4,4′-, 2,4′ and 2,2′-diaminodiphenylmethane, 3,3′-dichloro-4,4′-diaminodiphenylmethane (MOCA), tolylene-2,4- and -2,6-diamine, mixtures of 3,5-dimethylthiotolylene-2,4- and -2,6-diamine (obtainable as Ethacure® 300 from Albemarle), mixtures of 3,5-diethyltolylene-2,4- and -2,6-diamine

(DETDA), 3,3′, 5,5′-tetraethyl-4,4′-diaminodiphenylmethane (M-DEA), 3,3′, 5,5′-tetraethyl-2,2′-dichloro-4,4′-diaminodiphenylmethane (M-CDEA), 3,3′-diisopropyl-5,5′-dimethyl-4,4′-diaminodiphenylmethane (M-MIPA), 3,3′, 5,5′-tetraisopropyl-4,4′-diaminodiphenylmethane (M-DIPA), 4,4′-diaminodiphenyl sulfone (DDS), 4-amino-N-(4-aminophenyl)benzenesulfon-amide, 5,5′-methylenedianthranilic acid, dimethyl 5,5′-methylene-dianthranilate, propylene 1,3-bis(4-aminobenzoate), butylene 1,4-bis(4-aminobenzoate), polytetramethylene oxide bis(4-aminobenzoate) (obtainable as Versalink® from Air Products), 1,2-bis(2-aminophenylthio)-ethane, 2-methylpropyl 4-chloro-3,5-diaminobenzoate and tert-butyl 4-chloro-3,5-diaminobenzoate,
adducts of the polyamines mentioned with epoxides and epoxy resins, especially adducts with diepoxides in a molar ratio of at least 2/1, adducts with monoepoxides in a molar ratio of at least 1/1, and reaction products of amines and epichlorohydrin, especially that of 1,3-bis(aminomethyl)-benzene, commercially available as Gaskamine® 328 (from MGC);
polyamidoamines which are reaction products of a mono- or polybasic carboxylic acid, or the esters or anhydrides thereof, especially of a dimer fatty acid, and an aliphatic, cycloaliphatic or aromatic polyamine used in a stoichiometric excess, especially a polyalkylenamine, for example DETA or TETA, especially the commercially available polyamidoamines Versamid® 100, 125, 140 and 150 (from Cognis), Aradur0 223, 250 and 848 (from Huntsman), Euretek® 3607 and 530 (from Huntsman) and Beckopox® EH 651, EH 654, EH 655, EH 661 and EH 663 (from Cytec); and
phenalkamines, also called Mannich bases, which are reaction products of a Mannich reaction of phenols, especially cardanol, with aldehydes, especially formaldehyde, and polyamines, especially the commercially available phenalkamines Cardolite® NC-541, NC-557, NC-558, NC-566,

Lite 2001 and Lite 2002 (from Cardolite), Aradur®0 3440, 3441, 3442 and 3460 (from Huntsman) and Beckopox® EH 614, EH 621, EH 624, EH 628 and EH 629 (from Cytec).

Preferred polyamines are polyamines selected from the group consisting of pentane-1,3-diamine (DAMP), 1,5-diamino-2-methylpentane (MPMD), 2-butyl-2-ethylpentane-1,5-diamine (C11 neodiamine), hexane-1,6-diamine, 2,2,4- and 2,4,4-trimethylhexamethylenediamine (TMD), dodecane-1,12-diamine, 1,3-diaminocyclohexane, bis(4-aminocyclohexyl)methane (H12-MDA), bis(4-amino-3-methylcyclohexyl)methane, 1-amino-3-aminomethyl-3,5,5-trimethyl-cyclohexane (IPDA), 1,3-bis(aminomethyl)cyclohexane, 1,3-bis(aminomethyl)-benzene (MXDA), bishexamethylenetriamine (BHMT), diethylenetriamine (DETA), triethylenetetramine (TETA), tetraethylenepentamine (TEPA), pentaethylenehexamine (PEHA) and higher homologs of linear polyethylenamines such as polyethylenepolyamine having 5 to 7 ethylenamine units (HEPA), dipropylenetriamine (DPTA), N-(2-aminoethyl)-1,3-propane-diamine (N3 amine), N,N′-bis(3-aminopropyl)ethylenediamine (N4 amine), polyoxyalkylenediamines and polyoxyalkylenetriamines having a molecular weight in the range from 200 to 500 g/mol, especially the Jeffamine® D-230, Jeffamine® D-400 and Jeffamine® T-403 types, polyanilidoamines, phenalkamines, compounds of the polyamines mentioned which have been fully or partially alkylated at primary amino groups, and adducts of the polyamines mentioned with epoxides and epoxy resins. These preferred polyamines A have particularly good compatibility with epoxy resins.

Polyamines very particularly preferred in connection with the present invention are aliphatic polyamines. An especially preferred amine is 1-amino-3-aminomethyl-3,5,5-trimethylcyclohexane, alone or in a mixture with 2,2′-dimethyl-4,4′-methylene(cyclohexanamine).

In the context of the present invention, the hardener component may consist exclusively of the amines mentioned. However, it is also possible that the hardener component, as well as said hardener system, comprises water and optionally further admixtures such as, in particular, defoamer. In this case, it is preferable when the hardener makes up 1% to 25% by weight, especially 2% to 20% by weight, of the hardener component, based on the total weight thereof. The proportion to 100% by weight in this case consists preferably of water and the admixtures mentioned. A defoamer particularly preferred in connection with the present invention is BYK 023 (from BYK).

Cement Component

The cement component comprises cement and at least one filler. The cement used may be any available cement type or a mixture of two or more cement types, for example the cements classified under DIN EN 197-1: portland cement (CEM I), portland composite cement (CEM II), blast furnace slag cement (CEM 111), pozzolanic cement (CEM IV) and composite cement (CEM V). These main types are subdivided into 27 sub-classes which are immediately familiar to the person skilled in the art. It will be appreciated that cements which are produced according to an alternative standard, for example the ASTM standard or the Indian standard, are equally suitable.

Portland cement is the most frequently used cement type and can be used particularly appropriately in connection with the present invention. The cement is used globally and is a main constituent of concrete, mortar, stucco and grout. Portland cement is a grey powder which is obtained by grinding portland cement clinker (more than 90%) with a small proportion of calcium sulfate and up to 5% of further constituents, as defined in European Standard EN 197-1. The calcium sulfate in the cement serves to regulate the setting time. A cement preferred in the context of the present invention is portland cement, especially 1-42.5 R portland cement.

In addition to cement, the cement component contains at least one filler. Fillers are chemically inert solid particulate materials and are supplied in various forms and sizes and as different materials which vary from fine sand particles to large coarse stones. Examples of particularly suitable fillers are sand, gravel, comminuted stones, slag, calcined silica and lightweight fillers such as clay, pumice, perlite and vermiculite. Further advantageous fillers are alumina, calcium carbonate, fibers, especially polymer fibers, and amorphous silica (fumed silica). Preferably, the filler comprises sand, especially quartz sand, since this allows the processibility of the composition to be adjusted in an advantageous manner and a flat surface to be ensured.

The particle size of the fillers is preferably relatively small, i.e. less than 5 mm. The fillers may, for example, have a particle size in the range from 0.05 mm to 2.5 mm, particular preference being given to sand, especially quartz sand. For example, the use of sand having a particle size in the range from 0.1 to 0.6 mm, 0.3 to 0.9 mm, 0.7 mm to 1.2 mm and 1.5 to 2.2 mm or of a mixture thereof is associated with advantages. The particle size can be determined with the aid of sieve analysis.

The proportion of cement in the cement component is preferably in the range from 20% to 45% by weight, especially in the range from 25% to 40% by weight.

Sand constituents preferably account for 50% by weight or more in the cement component, particular preference being given to a range from 50% to 80% by weight, especially a range from 55% to 70% by weight.

In addition to the at least one filler and cement, especially quartz sand and portland cement, the cement component may comprise further admixtures which are immediately familiar to the person skilled in the art. For example, it is possible to add shrinkage reducing agents to the cement component.

Particularly suitable shrinkage reducing agents are calcium sulfoaluminates and/or neopentyl glycol. Further optional constituents of the cement component are plasticizers, thickeners, thixotropic agents, emulsifiers, flow agents, air pore formers, water retention agents, hydrophobizing agents, suspending agents, accelerators and/or retardants, which can be added by the person skilled in the art depending on the intended use properties. As well as these admixtures, all other admixtures known in mortar and concrete technology are also conceivable as additives.

The proportion of these admixtures in the cement component, based on the total weight of the cement component, should preferably not exceed 10% by weight. More preferably, the total amount of the admixtures should be 5% by weight or less, especially 3% by weight or less.

Polymeric Binder Which is Solid at 23° C

As explained above, the multicomponent composition of the invention contains 0.1% to 10% by weight, based on the total weight of the multicomponent composition, of at least one polymeric binder which is solid at 23° C. and which appropriately has a melting or softening temperature of more than 23° C. The solid polymeric binder is preferably a binder based on a water-dispersible powder, meaning that on introduction of the polymeric binder into water, a dispersion of the binder forms without occurrence of phase separation of the water and the binder. To improve the dispersion-forming properties of the polymeric binder, it may additionally contain small amounts of an emulsifier, especially in the form of polyvinyl alcohol.

The particle size of the dispersible powder is preferably in the range from 0.1 to 50 μm, more preferably in the range from 1 to 15 μm.

In addition, it is preferable in the context of the present invention when the at least one polymeric binder which is solid at 23° C. is based on an ethylene-vinyl acetate copolymer which may optionally contain one or more further comonomers. However, it is preferable when the proportion of such further comonomers does not exceed 10% by weight, based on the total weight of the ethylene-vinyl acetate copolymer. More particularly, the proportion of such further comonomers should be 5% by weight or less, more preferably 2% by weight or less.

The at least one polymeric binder which is solid at 23° C. preferably has a glass transition temperature (Tg) in the range from -10 to +20° C., especially -7 to +15° C. In the context of this invention, glass transition temperatures should be determined by DSC.

The person skilled in the art will be able to directly adjust the ratio of ethylene to vinyl acetate in corresponding copolymers in such a way that such glass transition temperatures can be established. Preferably, the weight ratio of ethylene vinyl acetate is range from 10:90 to 30:70.

In the context of the present invention, it is further preferable when the at least one polymeric binder which is solid at 23° C. is present in the multicomponent composition with a content of 0.25% to 5% by weight, especially 0.75% to 3.8% by weight and more preferably 1% to 3% by weight.

The polymeric binder which is solid at 23° C. is additionally preferably essentially free of epoxy constituents, i.e. polymerized, oligomeric and monomeric epoxides. “Essentially free” in this connection is understood to mean maximum contents of 10% by weight, based on the total weight of the polymeric binder which is solid at 23° C., preferably not more than 5% by weight and more preferably not more than 1% by weight.

Preferred Ratios in the Context of the Invention

For the multicomponent composition, it is appropriate when the weight ratio of the at least one epoxy resin in the epoxy component to the at least one hardener in the hardener component is in the range from 2.5:1 to 1:1, especially in the range from 1.9:1 to 1.3:1. The weight ratio of epoxy resin in the epoxy component to hardener in the hardener component, irrespective of the above, depends to a significant degree on the ratio of the epoxy-reactive functional groups in the hardener component to the epoxy functions in the epoxy component. For instance, the proportion of the functional groups reactive toward epoxy functions in the hardener component with respect to the epoxy functions in the epoxy component should not be more than 1:1, since too small a size of the epoxy polymer is otherwise achieved, which can significantly impair the hardness of the material. With regard to an epoxy excess, the present invention is not subject to such strict restrictions, since further hardening of epoxy resins is also possible via the hydroxyl functions formed in the course of the reaction of the hardener with the epoxy component. However, this generally requires a higher temperature, such that the ratio of the functional groups reactive toward epoxides, especially amine functions, in the hardener component to the epoxy functions in the epoxy component should preferably be in the range from 1.1:1 to 0.9:1. The ratio is preferably about 1:1.

In the context of the present invention, it is additionally preferable when the cement component makes up the most significant constituent of the multicomponent composition. More particularly, the cement component makes up about 70% to about 95% by weight, preferably about 75% to about 88% by weight, of the multicomponent composition. The amount to 100% by weight in each case is provided by the epoxy component, the hardener component, the at least one polymeric binder which is solid at 23° C. and any further components.

It is possible to add further constituents separately from these components, but this is less advantageous because of the additional complexity associated with still further components. In the context of the present invention, it is therefore preferable when the multicomponent composition consists essentially of an epoxy component, a hardener component, a cement component and at least one polymeric binder which is solid at 23° C. In addition, it is possible to mix the at least polymeric binder which is solid at 23° C. directly with the epoxy, hardener or cement component, which correspondingly reduces the number of components.

In the context of the present invention, it is preferable when the epoxy component makes up about 0.5% to 10% by weight, preferably about 1% to 5% by weight, of the multicomponent composition. In addition, it is preferable when the epoxy component, as well as at least one epoxy resin, comprises water, in which case the ratio of epoxy resin to water is preferably in the range from 3:1 to 1:1, more preferably in the region of 2:1.

For the hardener component, it is preferable when it makes up 1% to 20% by weight, especially 2% to 15% by weight, of the multicomponent composition. The hardener component appropriately likewise comprises water, in which case the proportion of the at least one hardener in the hardener component may be relatively low, and should preferably be in the range from 1% to 25% by weight, and more preferably in the range from 2% to 20% by weight. In addition, it is preferable when the proportion to 100% by weight of the hardener component is based on water and any additional defoamers.

A further aspect of the present invention relates to the use of at least one polymeric binder which is solid at 23° C. for improving the adhesion and/or compressive strength and/or for reducing the shrinkage of a multicomponent composition comprising an epoxy component, a hardener component and a cement component. For the epoxy, hardener and cement components and for the polymeric binder, the above remarks relating to preferred embodiments apply analogously.

A further aspect of the present invention relates to a process for producing a coated substrate, comprising the steps of
mixing an epoxy component comprising at least one reactive epoxy resin and a hardener component comprising at least one hardener for the epoxy resin,
adding a cement component comprising cement and at least one filler and 0.1% to 10% by weight, based on the total weight of the mixture, of at least one polymeric binder which is solid at 23° C. and optionally water to obtain an essentially homogeneous mixture,
applying the mixture to a substrate, and
hardening the mixture applied to obtain a coated substrate.

The substrate is preferably a floor, in which case the coating is a floor covering. More preferably, the floor covering is a self-leveling floor covering.

For the above-described process, it is not crucial that the at least one polymeric binder which is solid at 23° C. is added to the epoxy component which has already been mixed with the hardener component. It is likewise possible to add the at least one polymeric binder which is solid at 23° C. to the epoxy component and to mix it therewith before the hardener component is added. Alternatively, the solid polymeric binder can be added to the hardener component and mixed therewith before the epoxy component is added. With regard to the cement component, however, it is appropriate to add the latter to a mixture which already contains the water required for the hardening of the cement component.

For the epoxy, hardener and cement components referred to above and for the at least one polymeric binder which is solid at 23° C., the remarks relating to preferred embodiments from the above apply analogously in the context of the process described.

A further aspect of the present invention relates to a coated substrate obtainable by a process as described above. More particularly, the substrate is a coated floor, where the coating is a floor covering. The floor covering is preferably a self-leveling floor covering. However, the multicomponent composition according to the present invention is not restricted to the production of such floor coverings; instead, it is likewise possible to use such multicomponent compositions, for example, as screeds, walls, render and repair mortar.

The present invention is elucidated in detail hereinafter with reference to examples, but these have no relevance for the determination of the scope of protection of the present invention.

### EXAMPLES

Constituents of the Epoxy, Hardener and Cement Components

For the experiments which follow, an epoxy component A was used in the form of an emulsion composed of about 62% by weight of a bisphenol A/F resin mixture and 38% by weight of water.

The hardener component B1 used was a composition composed of 2.4% by weight of a modified amine hardener (based on 1-amino-3-aminomethyl-3,5,5-trimethylcyclohexane), 0.1% by weight of a defoamer and 97.5% by weight of water. A more highly concentrated hardener component B2 was also produced, which contained 18% by weight of the amine hardener, 0.75% by weight of the defoamer and 81.25% by weight of water.

The cement composition used was a mixture of 33% by weight 142.5R portland cement, about 62% by weight of sand having particle sizes in the range from 0.1 to 2.2 μm, 1% by weight of shrinkage reducing agent (based on calcium sulfoaluminate and neopentyl glycol), 2% by weight of calcium carbonate and about 1.2% by weight of a mixture of fibers, thickeners, amorphous silica and a chromate reducer.

The compositions referred to were used in a ratio of 1:14:84 (epoxy component, hardener component B1, cement component; tables 2 to 5) or in a ratio of 1:2.5:18.5 (epoxy component, hardener component B2, cement component; table 1). This gives rise to a proportion of epoxy resin in the composition of about 1% by weight and about 4% by weight respectively.

Added to these mixtures were polymeric binders in the form of Vinnapas® 7220 N, Vinnapas® 5044 N, Vinnapas® 7034 E and Vinnapas® 7031 A from

Wacker AG. The amount of these admixtures was in the range from 0% to 4% by weight, based on the total weight of all constituents of the composition. The corresponding compositions were produced by mixing the epoxy and hardener components and then adding the cement component and the polymeric binder.

The processibility, shrinkage characteristics, compressive strength and bond strength of the compositions thus produced were determined.

Processibility was determined by applying the composition to a conventional concrete paving slab and processing it thereon. Processibility was determined by the processor as a value on a scale from 1 to 4, on which 1 was the worst value and 4 the best.

Shrinkage characteristics were determined to standard EN 12617-4 on 4x4x16 cm prisms. Prior to the measurement, the prisms were hardened for 28 days.

Compressive strength was determined to standard EN 12190 on 4x4x16 cm prisms. Prior to the measurement, the prisms were hardened for 28 days.

Bond strength was determined to standard EN 1542 on a sandblasted concrete garden slab. Prior to the measurement, the composition on the slab was hardened for 28 days.

The parameters determined for the various compositions are shown in the following tables 1 to 5:

TABLE 1

| Amount of | | | | |
|---|---|---|---|---|
| Vinnapas | | | Compressive | |
| 7220N in | | Shrinkage | strength | Bond strength |
| % by wt. | Processibility | in mm/m | in MPa | in MPa |
| 0 | 2 | −0.442 | 60.1 | 3.7 |
| 0.5 | 2 | −0.452 | 60.3 | 3.9 |
| 1.0 | 2 | −0.504 | 60.8 | 4.1 |
| 2.0 | 1 | −0.627 | 61.5 | 4.3 |
| 3.0 | 1 | −0.654 | 59.6 | 3.9 |

TABLE 2

| Amount of | | | | |
|---|---|---|---|---|
| Vinnapas | | | Compressive | |
| 7220N in | | Shrinkage | strength | Bond strength |
| % by wt. | Processibility | in mm/m | in MPa | in MPa |
| 0 | 4 | −0.614 | 41.6 | 1.1 |
| 1.0 | 4 | −0.575 | 38.9 | 1.6 |
| 2.0 | 4 | −0.637 | 40.9 | 2.1 |
| 3.0 | 4 | −0.592 | 37.2 | 2.8 |

TABLE 3

| Amount of | | | | |
|---|---|---|---|---|
| Vinnapas | | | Compressive | |
| 5044N in | | Shrinkage | strength | Bond strength |
| % by wt. | Processibility | in mm/m | in MPa | in MPa |
| 0 | 4 | −0.614 | 41.6 | 1.1 |
| 0.25 | 3 | −0.627 | 39.8 | 2.1 |
| 1.0 | 4 | −0.504 | 38.2 | 2.1 |
| 2.0 | 4 | −0.442 | 41.8 | 2.0 |
| 3.0 | 3 | −0.488 | 42.1 | 2.7 |

TABLE 4

| Amount of | | | | |
|---|---|---|---|---|
| Vinnapas | | | Compressive | |
| 7034E in | | Shrinkage | strength | Bond strength |
| % by wt. | Processibility | in mm/m | in MPa | in MPa |
| 0 | 4 | −0.614 | 41.6 | 1.11 |
| 0.25 | 3 | −0.554 | 40.2 | 2.14 |
| 1.0 | 4 | −0.521 | 37.1 | 2.13 |
| 2.0 | 4 | −0.413 | 36.6 | 2.47 |
| 3.0 | 3 | −0.413 | 39.7 | 2.56 |

TABLE 5

| Amount of | | | | |
|---|---|---|---|---|
| Vinnapas | | | Compressive | |
| 7031H in | | Shrinkage | strength | Bond strength |
| % by wt. | Processibility | in mm/m | in MPa | in MPa |
| 0 | 4 | −0.614 | 41.6 | 1.11 |
| 0.25 | 4 | −0.542 | 39.5 | 1.38 |
| 1.0 | 4 | −0.448 | 37.3 | 1.63 |
| 2.0 | 4 | −0.442 | 32.8 | 1.37 |
| 3.0 | 4 | −0.385 | 30.3 | 2.86 |

It is clear from the above tables that the addition of polymeric binder which is solid at 23° C. can significantly improve the properties of the multicomponent composition of the invention in relation to shrinkage, in relation to compressive strength and in relation to bond strength. For instance, shrinkage in the case of addition of Vinnapas 5044N in some cases exhibits a significant improvement.

This polymer likewise shows the greatest increase in compressive strength: the values vary within the range from 41 MPa to 43 MPa. The use of the polymeric binder Vinnapas 7220N, in contrast, shows improved bond strength compared to compositions without a corresponding addition.

It is accordingly found that the addition of at least one polymeric binder which is solid at 23° C. can in some cases significantly improve the properties of multicomponent compositions based on an epoxy component, a hardener component and a cement component.

In the case of table 1, it should be noted that the processibilities reported are the result of a nonoptimized composition. However, the processibility can be improved by addition of appropriate additives such as plasticizers or thixotropic agents.

1. A multicomponent composition comprising
an epoxy component comprising at least one reactive epoxy resin,
a hardener component comprising at least one hardener for the at least one reactive epoxy resin,
a cement component comprising cement and at least one filler, and
0.1% to 10% by weight, based on the total weight of the multicomponent composition, of at least one polymeric binder which wherein in the polymeric binder is solid at 23° C.

2. The multicomponent composition as claimed in claim 1, wherein the epoxy component and/or the hardener component comprises water.

3. The multicomponent composition as claimed in claim 1, wherein the at least one filler in the cement component comprises sand, alumina, calcium carbonate, fibers and/or amorphous silica (fumed silica).

4. The multicomponent composition as claimed in claim 1, wherein the epoxy resin comprises a bisphenol F and/or bisphenol A resin.

5. The multicomponent composition as claimed in claim 1, wherein the hardener component comprises a polyamine.

6. The multicomponent composition as claimed in claim 1, wherein the at least one polymeric binder which is solid at 23° C. is a water-dispersible powder.

7. The multicomponent composition as claimed in claim 1, wherein the composition comprises 0.25% to 3% by weight of the at least one polymeric binder, which is solid at 23° C.

8. The multicomponent composition as claimed in claim 1, wherein the weight ratio of the at least one epoxy resin in the epoxy component to the at least one hardener in the hardener component is in the range of 2.5:1 to 1:1.

9. The multicomponent composition as claimed in claim 1, wherein the cement component comprises portland cement and quartz sand.

10. The multicomponent composition as claimed in claim 1, wherein the cement component makes up 70% to 95% by weight, of the multicomponent composition.

11. A method of improving the adhesion and/or compressive strength of and/or of reducing the shrinkage of a multicomponent composition, the method comprising adding at least one polymeric binder that is solid at 23° C. to the multicomponent composition, wherein the multicomponent composition comprises an epoxy component, a hardener component and a cement component.

12. A process for producing a coated substrate, the process comprising the steps of
mixing an epoxy component comprising at least one reactive epoxy resin and a hardener component comprising at least one hardener for the epoxy resin,
adding a cement component comprising cement and at least one filler and 0.1% to 10% by weight, based on the total weight of the mixture, of at least one polymeric binder, which is solid at 23° C., and optionally water to obtain an essentially homogeneous mixture,
applying the mixture to a substrate, and
hardening the mixture applied to obtain the coated substrate.

13. A coated substrate obtained by the process as claimed in claim 12.

14. The coated substrate as claimed in claim 13, wherein the coated substrate is a floor having a floor covering.

15. The multicomponent composition as claimed in claim 2, wherein the water in the epoxy component and/or the hardener component is present in an amount sufficient to harden the cement.

16. The multicomponent composition as claimed in claim 3, wherein the sand is quartz sand.

17. The multicomponent composition as claimed in claim 4, wherein the epoxy resin comprises a bisphenol F and/or bisphenol A epichlorohydrin resin.

18. The multicomponent composition as claimed in claim 5, wherein the polyamine in the hardener component is an aliphatic polyamine.

19. The multicomponent composition as claimed in claim 6, wherein the at least one polymeric binder is based on an ethylene-vinyl acetate copolymer, which can comprise one or more further comonomers.

20. The multicomponent composition as claimed in claim 8, wherein the ratio of the at least one epoxy resin to the at least one hardener in the hardener component is in the range of 1.9:1 to 1.3:1.

21. The multicomponent composition as claimed in claim 10, wherein the cement component makes up 75% to 88% by weight of the multicomponent composition.

22. The coated substrate as claimed in claim 14, wherein the floor covering is a self-leveling floor covering.
